(19) United States
(12) Patent Application Publication
(10) Pub. No.: US 2005/0283391 A1
(43) Pub. Date: Dec. 22, 2005

(54) Tool for organizing project-execution-management-related knowledge

(76) Inventor: Shih-Chieh Chou, Chung-Li (TW)

Correspondence Address: Chou, Shih-Chieh, NO. 54, Chung-Da-Shin-Tswin, National Central University, Chung-Li, 320, TW

(21) Appl. No.: 10/870,819

(22) Filed: Jun. 16, 2004

(51) Int. Cl. G06F 17/60

(52) U.S. Cl. 705/7

(57) ABSTRACT

A tool for organizing the project manager's project-execution-management-related (PEMR) knowledge. The tool includes a framework which is a hierarchically organized categorical structure utilized to categorize the project manager's PEMR knowledge. The tool includes a framework content editor which performs text creating, modifying, storing and retrieving for editing clues for the knowledge categorized into the framework. The framework and the clues together form a schema. Accessed and used through the well organized schema, the PEMR knowledge becomes structured.

### CROSS-REFERENCE TO RELATED APPLICATIONS NOT APPLICABLE

### STATEMENT REGARDING FEDERALLY SPONSORED RESEARCH NOT APPLICABLE

### REFERENCE TO SEQUENCE LISTING, A TABLE, OR A COMPUTER PROGRAM LISTING COMPACT DIST APPENDIX NOT APPLICABLE

### BACKGROUND OF THE INVENTION

1. Field of the Invention

The invention relates generally to the field of project management. More specifically, the invention relates to the organization of the project manager's knowledge. More particularly, the invention relates to the organization of the project manager's knowledge related to managing project execution.

2. Description of the Related Art

Project management generally comprises three phases, including project plan, project execution and project evaluation. In managing project execution (one project or many projects together), the project manager will make use of his project-execution-management-related (abbreviated as PEMR in the following) knowledge to generate management actions.

The project manager's PEMR knowledge, as we defined here, is the knowledge that is related or conducive to the generation of the project manager's management actions for managing project execution. Following are some examples of this knowledge: tasks listed in a plan, the occurrence of a low productivity problem, the management action previously taken, assignment techniques, sources of the project manager's power, Management By Objectives, and so forth. Normally, this knowledge is very scattered and unstructured because, first, the knowledge exists piece by piece, and second, the knowledge is generated dynamically and continually during project period. According to cognitive science, scattered and unstructured knowledge tends to become inert. Inert knowledge means that the knowledge is not applied although it is potentially useful. In managing project execution as mentioned, inert knowledge problem undoubtedly is very common. For example, the project manager may have learned “Management By Objectives” before, but this management knowledge is never used to generate management actions like setting up rewarding and punishing rules. Another example, the project manager may have taken some management actions to resolve project team's problems before, but this knowledge will never occur to him again to generate follow-up evaluation actions.

Prior art project management tools have been very well developed to assist project management work, but non of them provide the user with the ability to have the PEMR knowledge structured. The functions of these prior art tools mainly have to do with planning, communication, information sharing, problem handling, and the like. The leading project management tools like Primavera Enterprise or Microsoft Project Enterprise are typical examples.

Presently, human methods are the major way to structure PEMR knowledge. Natural behavioral model in managing a project can finally result in the structuring of PEMR knowledge. However, the process is complicated, tedious and time consuming. A modified behavioral model (self-controlled or imposed by a computer tool) [1] which aims to promote the efficiency in generating management actions can promote the efficiency in structuring PEMR knowledge as well. However, the inefficiency still exists for lack of a convenient tool for editing and reusing the PEMR knowledge structure. The other common human method is to organize the knowledge in a document in a structured way first and then study the document. The problem is that the dynamically and continually generated PEMR knowledge can not be maintained simultaneously.

Accordingly, it is the object of this invention to provide a tool for organizing the project manager's PEMR knowledge in a structured way.

### BRIEF SUMMARY OF THE INVENTION

The invention is directed to the offering of a tool for the project manager to organize his own PEMR knowledge in a structured way. In accordance with the invention, the tool will provide the project manager with a standard category for categorizing his PEMR knowledge in mind; also, the tool will provide the project manager with a content editor for editing clues, under each category, for the pieces of PEMR knowledge belonging to that category. The categories and the clues together form a schema of the project manager's PEMR knowledge. The schema and the knowledge trigged by the schema form a structured way of the project manager's PEMR knowledge. Thus, just by categorizing knowledge and editing knowledge clues at one's own will, one would be able to organize his PEMR knowledge in a structured way.

In accordance with the invention, the tool includes a framework for categorizing the project manager's PEMR knowledge. The framework consists of at least one first layer sub-framework titled “project” or the equivalent. A first layer sub-framework further includes two second layer sub-frameworks titled “plan” and “management action” individually or the equivalents. The first layer sub-framework can further include one to many second layer sub-frameworks titled “problem”, “management theory” and “general management action” individually or the equivalents. The second layer sub-framework titled “plan” can consist of one to many third layer sub-frameworks titled “work item”, “schedule”, “personnel”, “budget” and “resource” individually or the equivalents. The second layer sub-framework titled “management action” can consist of one to many third layer sub-frameworks titled “management action item” and “management action schedule” individually or the equivalents. The tool also includes a framework content editor for creating and editing clues in adequate sub-frameworks for the pieces of PEMR knowledge belonging to it.

The invention has several advantages over some or all present methods: 1. Simple categorizing work according to a standard category and some editing activities at one's own will replaces the tedious, complicated and time consuming manual/mental processes in structuring PEMR knowledge. 2. Reuse of schema through editing functions greatly promotes the efficiency of constructing new knowledge structure. 3. The dynamically and continually generated PEMR knowledge can be organized with the existing knowledge easily and simultaneously. 4. The constructed PEMR knowledge structure comprises a visual schema. Therefore, the use of PEMR knowledge has a visual schema (including framework and mnemonic clues) to assist instead of depending on complicated mental processing and memorizing capabilities only.

### BRIEF DESCRIPTION OF THE DRAWINGS

FIG. 1 shows an example of a framework in accordance with one embodiment of the invention.

FIG. 2 shows an example of a schema in accordance with one embodiment of the invention.

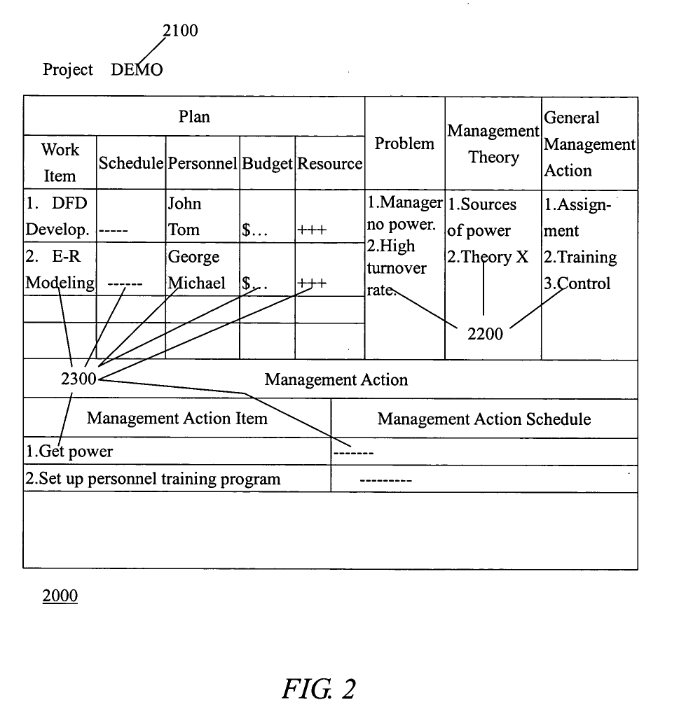

FIG. 3 shows an example of a structured PEMR knowledge in accordance with one embodiment of the invention.

FIG. 4 is flow chart showing a method of organizing PEMR knowledge in a structured way in accordance with one embodiment of the invention.

### DETAILED DESCRIPTION OF THE INVENTION

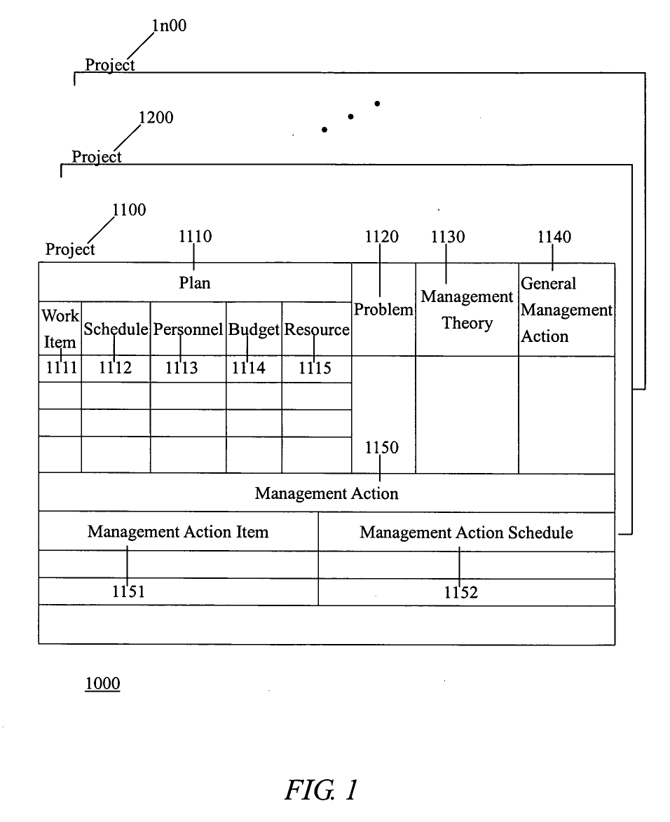

The invention is directed to a tool which is used by the project manager to organize his own PEMR knowledge in a structured way. In accordance with one preferred embodiment of the invention, the tool includes a framework 1000 as FIG. 1 shows. The framework 1000 is a hierarchically organized categorical structure utilized to categorize the project manager's PEMR knowledge. Decomposing from top, the framework 1000 is composed of one to many first layer sub-frameworks 1100, 1200, . . . , 1n00 titled “project” 1100, 1200, . . . , 1n00. In the preferred embodiment, a first layer sub-framework 1100 further includes five second layer sub-frameworks 1110, 1120, 1130, 1140, 1150 titled “plan” 1110, “problem” 1120, “management theory” 1130, “general management action” 1140 and “management action” 1150. And the second layer sub-framework 1110 titled “plan” 1110 is composed of five third layer sub-frameworks 1111, 1112, 1113, 1114, 1115 titled “work item” 1111, “schedule” 1112, “personnel” 1113, “budget” 1114 and “resource” 1115; the second layer sub-framework 1150 titled “management action” 1150 is composed of two third layer sub-frameworks 1151, 1152 titled “management action item” 1151 and “management action schedule” 1152.

The framework 1000 provided enables the project manager to categorize his own pieces of PEMR knowledge in mind first. In accordance with the preferred embodiment of the invention, the tool also includes a framework content editor. The framework content editor includes the function of text creation, modification, storing and retrieving as the usual computer editor. It is used to edit clues in the sub-framework for the knowledge categorized into that sub-framework. In accordance with the preferred embodiment, the framework 1000 and the framework content editor together enable the project manager to organize his PEMR knowledge in a structured way as follows: The project manager first creates the project identifier “DEMO” 2100 in a first layer sub-framework 1100; then, within this first layer sub-framework 1100, the project manager can edit clues 2200 for the knowledge categorized into the second layer sub-frameworks 1120, 1130, 1140 and clues 2300 for the knowledge categorized into the third layer sub-frameworks 1111, 1112, 1113, 1114, 1115, 1151, 1152.

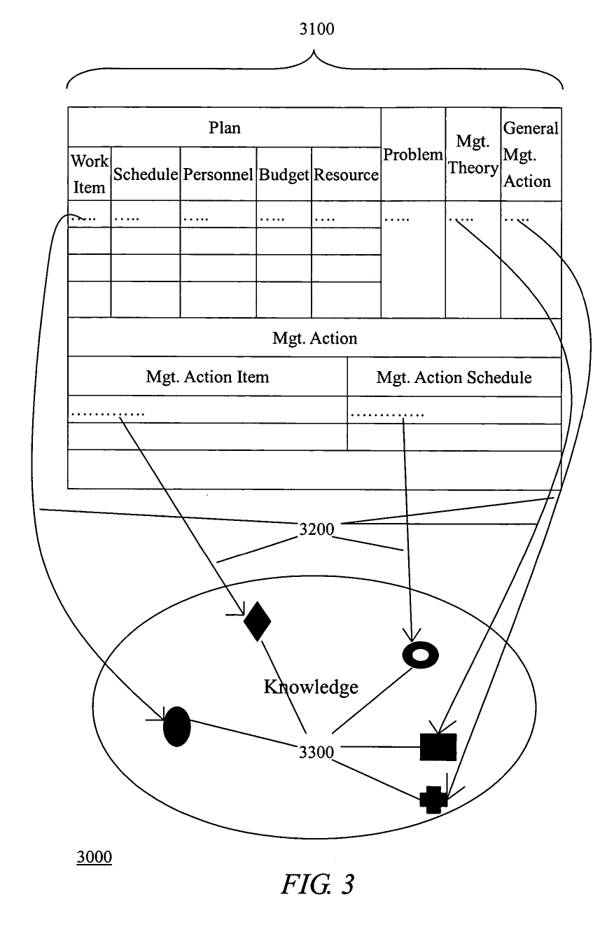

In this preferred embodiment, the sub-frameworks and the clues together form a structure referred to as schema 2000, 3100 here. The schema 2000, 3100 is the key to have the PEMR knowledge structured. As the project manager reads the schema 3100, the clue he reads would trigger 3200 the related PEMR knowledge 3300. In other words, the PEMR knowledge can be accessed and used through the well organized schema. Thus, the schema serves as a visual structure of the PEMR knowledge. As the project manager uses his own PEMR knowledge through the schema 3100, the schema 3100 and the knowledge 3300 triggered 3200 together form a PEMR knowledge structure 3000 shown in FIG. 3.

In accordance with the invention, the tool enables the project manager to organize his own PEMR knowledge in a structured way by categorizing in mind the pieces of PEMR knowledge according to a standard category and editing clues for the pieces of PEMR knowledge. Based on the editing function of the framework content editor, the organizing work can be processed at one's own will. Also, based on the editing function of the framework content editor, reuse of schema becomes easy and this could greatly promote the efficiency in constructing new PEMR knowledge structure. Owing to the provision of editing function again, change on the existing schema becomes easy and this makes simultaneous organizing with the dynamically and continually generated PEMR knowledge possible.

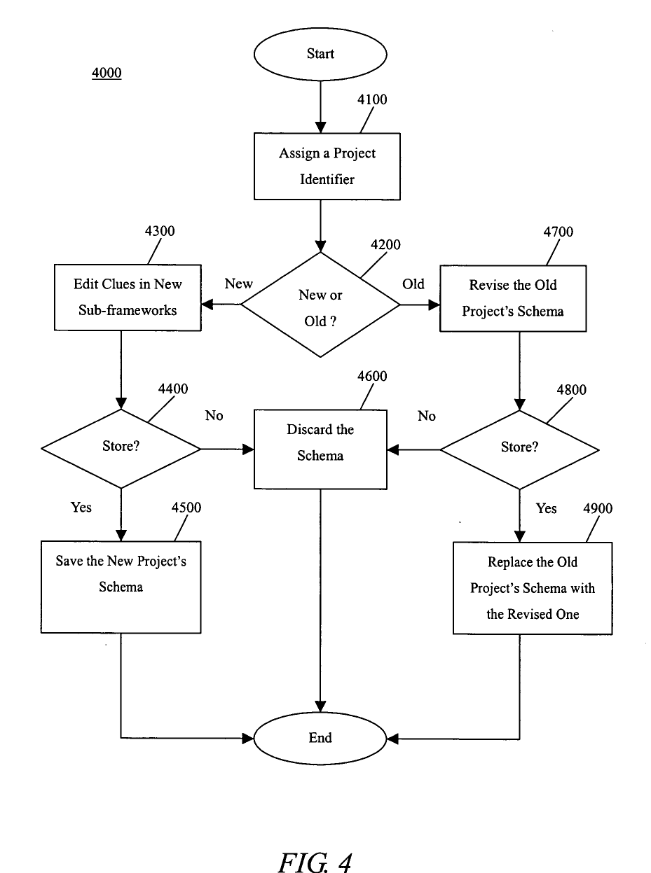

FIG. 4 shows a flow chart 4000 for using the tool according to the invention. The process begins with the step of assigning a project identifier in a first layer sub-framework 4100. The next step followed then checks the status of the project identifier 4200. In the case of a new project, the tool will present new sub-frameworks for the clue editing 4300. After finishing the clue editing, one has to decide whether or not to store the schema 4400. If the decision is positive, the new project's schema will be saved 4500; else, the schema will be discarded 4600. In the case of an old project, the tool will present the old project's schema for revision 4700. After finishing the revision, one has to decide whether or not to store the revised schema 4800. If the decision is positive, the old project's schema will be replaced with the revised one 4900; else, the revised schema will be discarded 4600.

The invention may be embodied in other specific forms without departing from the spirit or essential characteristics as described herein. Therefore, the present embodiments are to be considered in respects as illustrative and not restrictive. Accordingly, the invention shall be limited in scope only by the attached claims.

1. A tool for organizing project-execution-management-related knowledge, comprising:
A. a framework for categorizing the project manager's project-execution-management-related knowledge;
B. a framework content editor for editing clues for the pieces of project-execution-management-related knowledge categorized into said framework, said framework content editor's function includes text creating, modifying, storing and retrieving as a usual computer editor.

2. The tool for organizing project-execution-management-related knowledge according to claim 1 wherein said framework consists of at least one first layer sub-framework titled “project” or the equivalent, said first layer sub-framework includes two second layer sub-frameworks titled “plan” and “management action” individually or the equivalents.

3. The tool for organizing project-execution-management-related knowledge according to claim 2 wherein said second layer sub-framework titled “plan” consists of two third layer sub-frameworks titled “work item” and “schedule” individually or the equivalents.

4. The tool for organizing project-execution-management-related knowledge according to claim 3 wherein said second layer sub-framework titled “plan” further includes a third layer sub-framework titled “personnel” or the equivalent.

5. The tool for organizing project-execution-management-related knowledge according to claim 1 wherein said framework consists of at least one first layer sub-framework titled “project” or the equivalent, said first layer sub-framework includes two second layer sub-frameworks titled “problem” and “management action” individually or the equivalents.

6. The tool for organizing project-execution-management-related knowledge according to claim 1 wherein said framework consists of at least one first layer sub-framework titled “project” or the equivalent, said first layer sub-framework includes two second layer sub-frameworks titled “management theory” and “management action” individually or the equivalents.

7. The tool for organizing project-execution-management-related knowledge according to claim 1 wherein said framework consists of at least one first layer sub-framework titled “project” or the equivalent, said first layer sub-framework includes two second layer sub-frameworks titled “general management action” and “management action” individually or the equivalents.

8. The tool for organizing project-execution-management-related knowledge according to claim 1 wherein said framework consists of at least one first layer sub-framework titled “project” or the equivalent, said first layer sub-framework includes three second layer sub-frameworks titled “plan”, “problem” and “management action” individually or the equivalents.

9. The tool for organizing project-execution-management-related knowledge according to claim 8 wherein said second layer sub-framework titled “plan” consists of two third layer sub-frameworks titled “work item” and “schedule” individually or the equivalents.

10. The tool for organizing project-execution-management-related knowledge according to claim 9 wherein said second layer sub-framework titled “plan” further includes a third layer sub-framework titled “personnel” or the equivalent.

11. The tool for organizing project-execution-management-related knowledge according to claim 1 wherein said framework consists of at least one first layer sub-framework titled “project” or the equivalent, said first layer sub-framework includes four second layer sub-frameworks titled “plan”, “problem”, “management theory” and “management action” individually or the equivalents.

12. The tool for organizing project-execution-management-related knowledge according to claim 11 wherein said second layer sub-framework titled “plan” consists of two third layer sub-frameworks titled “work item” and “schedule” individually or the equivalents.

13. The tool for organizing project-execution-management-related knowledge according to claim 12 wherein said second layer sub-framework titled “plan” further includes a third layer sub-framework titled “personnel” or the equivalent.

14. The tool for organizing project-execution-management-related knowledge according to claim 13 wherein said second layer sub-framework titled “plan” further includes two third layer sub-frameworks titled “budget” and “resource” individually or the equivalents and said second layer sub-framework titled “management action” consists of two third layer sub-frameworks titled “management action item” and “management action schedule” individually or the equivalents.

15. The tool for organizing project-execution-management-related knowledge according to claim 1 wherein said framework consists of at least one first layer sub-framework titled “project” or the equivalent, said first layer sub-framework includes five second layer sub-frameworks titled “plan”, “problem”, “management theory”, “general management action” and “management action” individually or the equivalents.

16. The tool for organizing project-execution-management-related knowledge according to claim 15 wherein said second layer sub-framework titled “plan” consists of two third layer sub-frameworks titled “work item” and “schedule” individually or the equivalents.

17. The tool for organizing project-execution-management-related knowledge according to claim 16 wherein said second layer sub-framework titled “plan” further includes a third layer sub-framework titled “personnel” or the equivalent.

18. The tool for organizing project-execution-management-related knowledge according to claim 17 wherein said second layer sub-framework titled “plan” further includes two third layer sub-frameworks titled “budget” and “resource” individually or the equivalents and said second layer sub-framework titled “management action” consists of two third layer sub-frameworks titled “management action item” and “management action schedule” individually or the equivalents.
